(19) United States
(12) Patent Application Publication
(10) Pub. No.: US 2025/0258703 A1
(43) Pub. Date: Aug. 14, 2025

(54) SYSTEMS AND METHODS OF DYNAMIC SCHEDULING

(71) Applicant: Salesforce, Inc., San Francisco, CA (US)

(72) Inventors: Vimal SHARMA, Bangalore (IN); Sushmita RANJAN, Hyderabad (IN); Abhay VYAS, Bangalore (IN)

(21) Appl. No.: 18/441,449

(22) Filed: Feb. 14, 2024

(51) Int. Cl. G06F 9/48; G06F 9/50

(52) U.S. Cl. CPC G06F 9/4881; G06F 9/505; G06F 2209/501; G06F 2209/503

(57) ABSTRACT

Systems and methods for receiving, at a server that includes a reschedule handler, a request with a service resource by a requestor. The server determines one or more available resources of the service resource to handle the request. At least one match between one or more criteria of the request and the availability of the one or more resources of the service resource is determined. A time slot for the requestor with the service request is scheduled based on the determined at least one match and based on an acceptance of the request by the service resource that is received by the server. The server transmits the scheduled time slot with the service resource to the requestor.

### BACKGROUND

Presently, a user scheduling time slots with a service resource or rescheduling a time slot with the service resource are handled manually by an administrator or operator. If a request for a time slot is made with the service resource (e.g., an emergency time slot), the administrator or operator for the service resource can manually grant the request for the emergency time slot, and subsequent appointments are delayed without notifications or adjustments to the electronic calendar to accommodate the emergency appointment. That is, there are no electronic adjustments in an electronic calendar system of the service resource to accommodate the emergency request.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-3 show example methods of dynamic scheduling of a service resource according to implementations of the disclosed subject matter.

FIGS. 4-5 shows an example dynamic scheduler to handle requests for emergency time slots with the service resource to an implementation of the disclosed subject matter.

FIG. 6 shows an example computer system of the dynamic scheduler of FIGS. 4-5 according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter may accommodate an emergency appointment with a service resource (e.g., dentist, medical doctor, therapist, physical therapist, accountant, lawyer, banker, venture capitalist, finance professional, architect, plumber, auto mechanic, roofer, electrician, or the like) by providing automatic dynamic scheduling with an electronic calendar of the service resource. If the service resource has the resources to handle the request and accepts the emergency time slot request, other scheduled time slots with the service resource for other users (e.g., stakeholders) be automatically adjusted within an electronic calendar system.

In implementations of the disclosed subject matter, the dynamic scheduler (e.g., a reschedule handler as described herein) may take inputs such as: free available slots in the electronic calendar of the service resource; properties of different time slots in the calendar of service resource; time slot configurations like free minutes before and after every time slot (block time); and/or reschedule policies for time slots which can be configured by service resource, and the like. Using one or more of the inputs, the dynamic scheduler may provide a scheduling modification proposal to accommodate the emergency time slot request.

In some implementations, the scheduling modification proposal generated by the dynamic scheduler may be provided to the service resource which may choose to either decline or accept the request for the emergency time slot based on the proposal. In some implementations, the dynamic scheduler may decide to reschedule other appointments based on the scheduling modification proposal and/or the insight/discretion of the service resource.

If the request is accepted by service resource, then the electronic calendar of service resource may be tentatively scheduled for the new affected appointments and the affected user and/or stakeholders may be informed with an electronic message. In some implementations, the affected users and/or stakeholders may have a choice to either accept the new proposed time or to book a new appointment with same or different service resource, or decline the proposal which may triggering another workflow/rule to reschedule other time slots to accommodate the request.

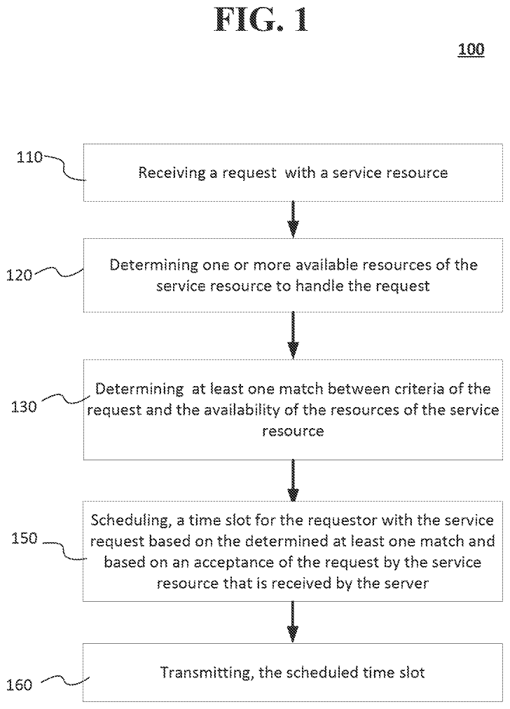

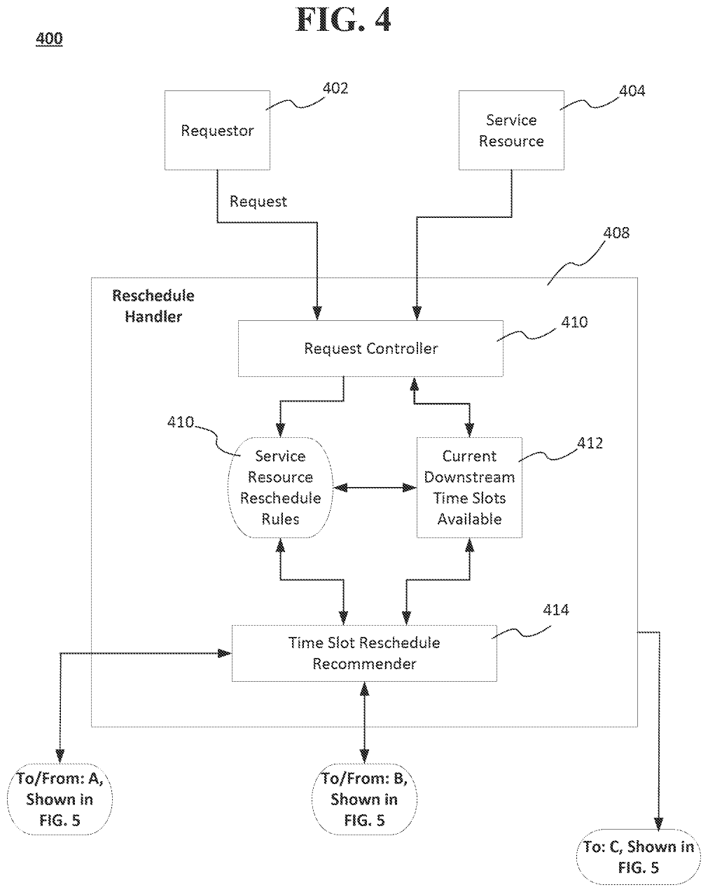

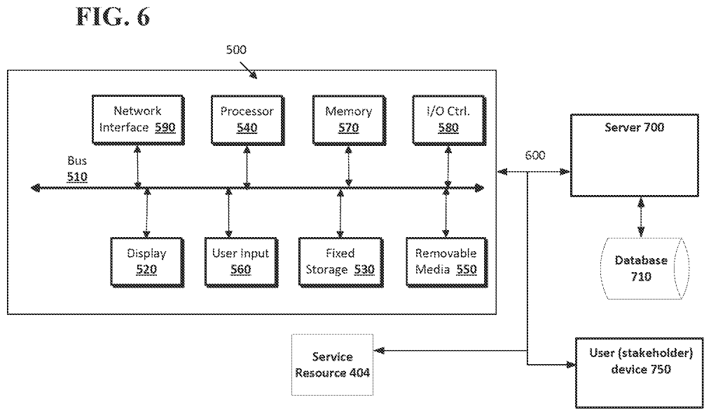

FIGS. 1-3 show example operations of a method 100 of dynamic scheduling of a service resource according to implementations of the disclosed subject matter. At operation 110 shown in FIG. 1, a server that includes a reschedule handler of the service resource may receive a request (e.g., a squeeze-in request) with a service resource by a requestor. The server may be server 700 shown in FIG. 6 and described below, and may include the reschedule handler, which may be reschedule handler 408 shown in FIG. 4. The service resource may be service resource 404 shown in FIGS. 4 and 6, and the requestor that issues the request may be requestor 402 shown in FIG. 4 and/or computer 500 shown in FIG. 6. The request may for an urgent and/or emergency time slot with the service resource that has not been previously scheduled. In some implementations, the service resource may be a dentist, medical doctor, therapist, physical therapist, accountant, lawyer, banker, venture capitalist, finance professional, architect, plumber, auto mechanic, roofer, electrician, or the like.

At operation 120, the server may determine one or more available resources of the service resource to handle the request. That is, the server may determine whether the service resource has the resources to handle the request (e.g., staff, materials, time, expertise, skills, or the like). In some implementations, the server may determine the one or more available resources by determining an amount of time needed for the request, and resources needed by the service resource for the request.

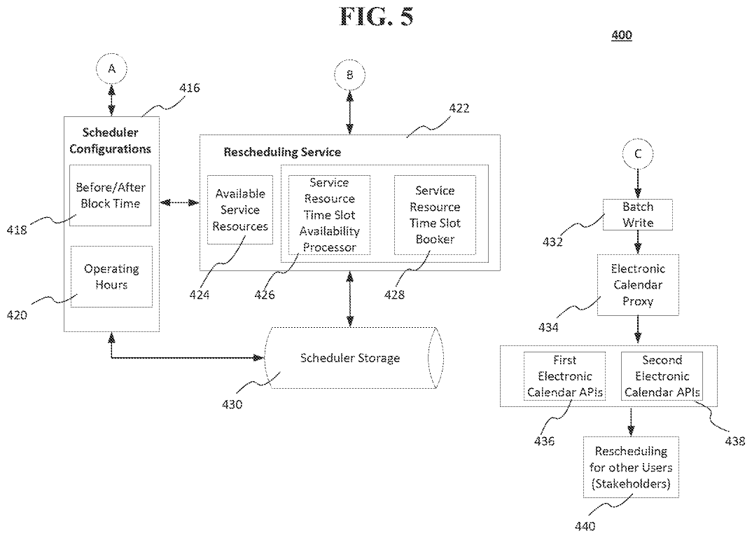

As an example of operation 120, the request controller 410 of the reschedule handler 408 shown in FIG. 4 may communicate with service resource reschedule rules 410 to determine the resources available to the service resource. Example rules for service resource reschedule rules 410 may include an after block time (e.g., a time amount after a time slot may be greater than or equal to 5 minutes, 10 minutes, or the like), time slots with a hard start time or hard stop time may not be rescheduled, a time slot of a particular type (e.g., a high priority healthcare time slot may not be rescheduled), or the like. The controller 410 may communicate with current downstream slots available 412 to determine open time slots available for the request and/or to move presently scheduled time slots to. The reschedule rules and the time slots available may be used by the request controller 410 of the reschedule handler 408 to determine the resources (e.g., available time to accommodate a request) available to the service resource 404 to accommodate the request received by the request controller 410 from the requestor 402. As shown in FIGS. 4-5, the time slot reschedule recommender 414 may communicate with scheduler configurations 416 to determine the before and/or after block time from the before/after block time 418 for the scheduled time blocks (e.g., a time amount after a time slot may be greater than or equal to 5 minutes, 10 minutes, or the like), and/or with the operating hours 420 to determine the hours of operation for the service resource 404. The time slot reschedule recommender 414 may communicate with the available service resources 424 of the rescheduling service 422 via a wired and/or wireless communications link to determine the available resources of the service resource 404.

At operation 130, the server may determine at least one match between one or more criteria of the request and the availability of the one or more resources of the service resource. The request received by the server may include one or more criteria. For example, the criteria may include a severity type (e.g., minor, moderate, major, critical, or the like), a customer type (e.g., standard, medium value, high value, or the like), the number of requests already received, a predetermined maximum number of requests per day, a time requested and whether it is within the working hours of the service resource, and the like.

As an example of operation 130, the reschedule handler 408 may communicate with the available resources 424 of the rescheduling service 422 via a wired and/or wireless communications link to determine whether there is at least one match between one or more criteria of the request from the requestor 402 and the availability of the one or more resources of the available service resources 424 of the service resource 404. The rescheduling service 422 may communicate with the scheduler configurations 416 and/or the scheduler storage 430 via a wired and/or wireless communications link to determine the resources (e.g., block times, operating hours, and the like) of the service resource 404.

In some implementations, the server may determine available resources based on, for example, the remaining number of slots for the service resource, a requested time slot with the service resource, and/or a minimum time that can be taken from an existing time slots reserved with the service resource by others with the service resource.

In some implementations, the one or more criteria include, for example, a severity level of the request, a type of the requestor, number of requests already received by the service resource, maximum number of assigned time slots per day with the service resource, and/or an amount of time that can be taken from an existing assigned time slot with the service resource.

In some implementations, the server may determine, in a first operation, the resources available to the service resource. In a second operation, the server may determine whether the remaining number of time slots of the day for the service resource is greater than or equal to the requested time slot divided by the minimum time that can be taken from an existing time slot that has been reserved by another user. When a Boolean AND operation performed by the server between the first operation and the second operation yields a positive result, a match may be determined between the request criteria and the service resource availability.

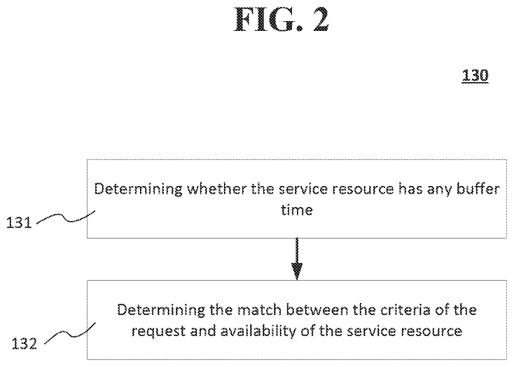

FIG. 2 shows example operations for determining the at least one match in operation 130. At operation 131, the server may determine whether the service resource has any buffer time between currently assigned time slots with the service resource. At operation 132, the server may determine the match between the one or more criteria of the request and availability of the service resource when it is determined that there is buffer time between current appointments and based on the one or more criteria of the request.

At operation 140 of method 100 shown in FIG. 1, the server may schedule a time slot for the requestor with the service request based on the determined at least one match and based on an acceptance of the request by the service resource that is received by the server. In some implementations, the scheduling the time slot for the requestor may include determining, at the server, a match from a list of matches between the one or more criteria of the request and the availability of the one or more resources of the service resource. In some implementations, the server may perform the scheduling by taking a predetermined minimum time interval from at least one other previously scheduled time slot with the service resource to schedule the time slot for the requestor.

As an example of operation 140, the time slot schedule recommender 414 of the reschedule handler 408 may recommend one or more time slots based on data provided by the scheduler configurations 416, the rescheduling service 422, and/or the scheduler storage 430. The rescheduling service 422 may schedule a time slot for the requestor 402 with the service resource 404 based on the determined at least one match and based on an acceptance of the request by the service resource 404 that is received by the request handler 404. In some implementations, the time slot reschedule recommender 414 may propose one or more recommendations to the service resource 404 as to how to accommodate the request by the requestor 404 based on the schedule and resource availability of the service resource 404. In some implementations, the service resource may accept one of the recommendations, and the reschedule handler 408 may communicate via a wired and/or wireless communications link with batch write 432, which may schedule the request with the requestor 402 in an electronic calendar of the service resource 404 using calendar proxy 434, and at least one of the first electronic calendar APIs (application programming interface) 436 and the second electronic calendar APIs 438. Although only two electronic calendar APIs are shown, there may be more than two electronic calendar APIs, where different electronic calendar applications may have different electronic calendar APIs. Using the electronic calendar APIs, the scheduled time slots with other users (i.e., stakeholders, or others besides the requestor 402) with the service resource 404 may be rescheduled at rescheduling 440.

In some implementations, the reschedule handler 408 may reschedule one or more downstream time slots of the service resource 404 by using the batch write 432 and the calendar proxy 434 as one request to update the calendars for each of the users who have time slots scheduled with the service resource 404. At least one of the first electronic calendar APIs (application programming interface) 436 and the second electronic calendar APIs 438 may be used to reschedule the downstream time slots.

At operation 150, the server may transmit the scheduled time slot with the service resource to the requestor. For example, the reschedule handler 408 may transmit the scheduled time slot with the service resource 404 to the requestor 402.

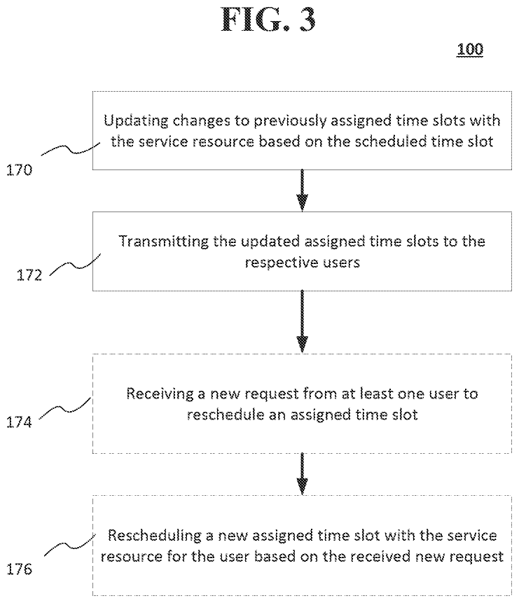

FIG. 3 shows optional additional operations of method 100 according to implementations of the disclosed subject matter. At operation 170, the server may update changes to previously assigned time slots with the service resource based on the scheduled time slot for the requestor. At operation 172, the server may transmit and the updated assigned time slots to respective users (e.g., stakeholders) of the service resource. In some implementations, method 100 may include operation 174, where the server may receive a new request from at least one user to reschedule an assigned time slot based with the service resource or schedule a time slot with another service resource based on the updated assigned time slots. At optional operation 176, the server may reschedule a new assigned time slot with the service resource for the user based on the received new request.

FIGS. 4-5 shows an example system 400 of a dynamic scheduler to handle requests for emergency time slots with the service resource to an implementation of the disclosed subject matter. System 400 may perform one or more operations of the example method 100 described above in connection with FIGS. 1-3. The requestor 402 may a computer, tablet computing device, smartphone, wearable computing device, or the like that may generate and transmit the request to the reschedule handler 408. In some implementations, the requestor may be computer 500 shown in FIG. 6 and described below. Service resource 404 may be a computer, server, virtual server, cloud computing device, table computing device, smartphone, wearable computing device, or the like which may accept the request by the requestor 402. In some implementations, the requestor may be computer 500 or a server similar to server 700 shown in FIG. 6 and described below.

The reschedule handler 408 may be at least one server, virtual server, cloud computing device, or the like. For example, the reschedule handler may be server 700 shown in FIG. 6 and described below. The reschedule handler may include the request controller 410, which may be at least part of a processor, a field programmable gate array (FPGA), a programmable logic device (PLD), electrical control circuit, or the like of the server. The request handler 408 may include the service resource reschedule rules 410, the current downstream time slots available 412 that may be communicatively coupled to the request controller 410, as well as to one another, and to the time slot reschedule recommender 414. As described above, the service resource reschedule rules 410 may include one or more rescheduling rules for the service resource 404, which may include, for example, an after block time (e.g., a time amount after a time slot may be greater than or equal to 5 minutes, 10 minutes, or the like), time slots with a hard start time or hard stop time may not be rescheduled, a time slot of a particular type (e.g., a high priority healthcare time slot may not be rescheduled), or the like. The current downstream time slots available 412 may store available time slots that may be available to the requestor 402 with the service resource 404 after the request is received. The time slot reschedule recommender 414 may be at least part of a processor, a field programmable gate array (FPGA), a programmable logic device (PLD), electrical control circuit, or the like that is part of the server, virtual server, cloud computing device, or the like. As described above, the time slot reschedule recommender 414 may determine the available resources and times of the service resource 404, and may generate one or more recommendations in the schedule of the service resource 404 to accommodate the request of the requestor 402.

The time slot reschedule recommender 414 may communicate via a wired and/or wireless communications link with schedule configurations 416, which may include before/after block time 418 and operating hours 420. The schedule configurations 416 may be a server, virtual server, and/or computing device that is separate from the server that includes the reschedule handler 408, and/or may be part of the same server as the reschedule handler 408. As described above, before/after block time 418 may be a time amount after a scheduled time slot, and the operating hours 420 may be the hours of operation for the service resource 404. The time slot reschedule recommender 414 may communicate via a wired and/or wireless communications link with a scheduler storage 430, which may be one or more hard drives, solid state drives, USB (universal serial bus) drives, and/or any other machine-readable storage medium. In some implementations, the scheduler storage 430 may store a schedule of the service resource 404, which may include time slots that have already been scheduled with other users, and/or include open time slots (e.g., within the hours of operation) of the service resource 404.

The time slot reschedule recommender 414 may communicate via a wired and/or wireless communications link with rescheduling service 422, which may be a server, virtual server, and/or computing device that is separate from the server that includes the reschedule handler 408, and/or may be part of the same server as the reschedule handler 408. The rescheduling service 422 may include available service resources 424, service resource appointment availability processor 4256, and service resource time slot booker 428. The available service resources 424 may include, for example, one or more resources that the service resource 404 may have available to the requestor 402 and/or other users. The service resource time slot availability processor 426 may determine if the service resource 404 has any available time slots for the requestor and/or other users for one or more days and/or times. The service resource time slot booker 428 may schedule a time slot between the service resource 404 and the requestor 402 and/or other users based on the determined available resource and the time slot availability, along with an acceptance of the request by the service resource 404. The time slot reschedule recommender 414 may communicate via a wired and/or wireless communications link with the scheduler storage 430, which may include the time slots that have already been scheduled with other users, and/or include open time slots.

The reschedule handler 408 may be communicatively coupled via a wired and/or wireless communications link with batch write 432, electronic calendar proxy 434, first electric calendar APIs 436, second electronic calendar APIs 438, and rescheduling for others 440, which may be at least part of a different computer, server, virtual server, and/or cloud computing device from reschedule handler 408, and/or may be part of the same computer, server, virtual server, and/or cloud computing device. Batch write 432 may be configured to perform an operation to bulk reschedule a plurality of time slots with the service resource 404. The bulk reschedule request may be transmitted to the calendar proxy 434 as, for example, one request to update the electronic calendar of the service resource 404. The first electric calendar APIs 436 may be APIs for a first type of electronic calendar, and the second electronic calendar APIs 438 may be APIs for a second type of electronic calendar. The requestor 404, the service resource 404, and one or more other users (e.g., stakeholders) may have the same type of electronic calendar, or may have different electronic calendars. The different APIs may be used to interface with the different types of electronic calendars to store and/or retrieve calendar information, and/or to schedule time slots. The rescheduling for other Users 440 may be configured to adjust time slots by one or more other users that are scheduled with the service resource 404 based on the scheduling of a time slot of the requestor 402 with the service resource 404.

Implementations of the presently disclosed subject matter may be implemented in and used with a variety of component and network architectures. FIG. 6 is an example computer 500 suitable for the operations detailed in method 100 and FIGS. 1-3. As discussed in further detail herein, the computer 500 and/or one or more user (e.g., stakeholder) devices 750 may be a single computer in a network of multiple computers. The computer 500 may be requestor 402 shown in FIG. 4. In some implementations, the computer 500 may be used to execute one or more applications that may request data and/or processing from one or more services provided by server 700 and/or database 710. As shown in FIG. 6, the computer 500 may communicate with a server 700, service resource 404, and/or one or more user (stakeholder) devices 750 via a wired and/or wireless communications network 600. The server 700 and/or the service resource 750 may be a hardware server, virtual machine, cloud server, database, cluster, application server, neural network system, or the like. Although one server 700 and database 710 are shown, there may be a plurality of servers and or databases communicatively coupled to communications network 600. The reschedule handler 408 shown in FIG. 4 and/or the schedule configurations 416, rescheduling service 422, the batch write 432, electronic calendar proxy 434 first electronic calendar APIs 436, the second electronic calendar APIs 438, and the rescheduling for other users 440 may be part of server 700 and/or one or more separate servers, virtual machines, cloud server, or the like. In some implementations, the service resource 750 may be a computer similar to computer 500. The server 700 may be communicatively coupled to database 710 and/or may include database 710. The database 710 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as service resource calendar data, open time slots of the service resource, scheduled time slots of the service resource, and the like, and the like. In some implementations, the database 710 may be the scheduler storage 430 shown in FIG. 5.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks. The service resource 404 and/or one or more user devices 750 may have components that are similar to the computer 500 described above.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 6 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving”, “determining”, “scheduling”, “transmitting”, “updating”, “rescheduling”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
receiving, at a server that includes a reschedule handler, a request with a service resource by a requestor;
determining, at the server, one or more available resources of the service resource to handle the request;
determining, at the server, at least one match between one or more criteria of the request and the availability of the one or more resources of the service resource;
scheduling, at the server, a time slot for the requestor with the service request based on the determined at least one match and based on an acceptance of the request by the service resource that is received by the server; and
transmitting, at the server, the scheduled time slot with the service resource to the requestor.

2. The method of claim 1, wherein the determining the one or more available resources comprises:
determining an amount of time needed for the request, and resources needed by the service resource for the request.

3. The method of claim 1, wherein the determining the at least one match further comprises:
determining, at the server, available resources based on at least one selected from a group consisting of: remaining number of slots for the service resource, a requested time slot with the service resource, and a minimum time that can be taken from an existing time slots reserved with the service resource by others with the service resource.

4. The method of claim 1, wherein the one or more criteria include at least one selected from a group consisting of: a severity level of the request, a type of the requestor, number of requests already received by the service resource, maximum number of assigned time slots per day with the service resource, and an amount of time that can be taken from an existing assigned time slot with the service resource.

5. The method of claim 1, wherein the determining the at least one match further comprises:
determining, at the server, whether the service resource has any buffer time between currently assigned time slots with the service resource; and
determining, at the server, the match between the one or more criteria of the request and availability of the service resource when it is determined that there is buffer time between current appointments and based on the one or more criteria of the request.

6. The method of claim 1, wherein the scheduling the time slot for the requestor further comprises determining, at the server, a match from a list of matches between the one or more criteria of the request and the availability of the one or more resources of the service resource.

7. The method of claim 1, further comprising:
updating, at the server, changes to previously assigned time slots with the service resource based on the scheduled time slot for the requestor; and
transmitting, at the server, the updated assigned time slots to respective users of the service resource.

8. The method of claim 7, further comprising:
receiving, at the server, a new request from at least one user to reschedule an assigned time slot based with the service resource or schedule a time slot with another service resource based on the updated assigned time slots; and
rescheduling, at the server, a new assigned time slot with the service resource for the user based on the received new request.

9. The method of claim 1, wherein the scheduling comprises taking a predetermined minimum time interval from at least one other previously-scheduled time slot with the service resource to schedule the time slot for the requestor.

10. A system comprising:
a server comprising:
a reschedule handler, comprising:
a request controller configured to receive a request for access to a service resource from a requestor, and to receive a response to the request from the service resource;
a storage device that is configured with the service resource reschedule rules and data regarding scheduling slots for the service resource; and
an reschedule recommender configured to provide rescheduling information to the requestor based on at least the service resource reschedule rules and data regarding scheduling slots for the service resource.

11. The system of claim 10, wherein the server further comprises:
a rescheduling service communicatively coupled to the reschedule handler that is configured with service resource time slots and a service resource appointment booker; and
a scheduler configuration communicatively coupled to the rescheduling service and the reschedule handler that stores time configurations for scheduling,
wherein the reschedule handler uses the service resource time slots and service resource appointment booker of the rescheduling service and the time configurations of the scheduler configuration to provide rescheduling information to the requestor.

12. The system of claim 11, wherein the time configurations of the scheduler configuration include at least one selected from a group consisting of: before or after block time information for a schedule block, and operating hours configuration.

13. The system of claim 10, further comprising:
a calendar proxy communicatively coupled to the reschedule handler that is configured to interface with one or more calendar application programming interfaces (APIs).

14. The system of claim 13, wherein one or more of the APIs are configured to interface with a calendar application of at least one selected from a group consisting of: a device of the requestor, and a device of the service resource.
